(19) United States
(12) Patent Application Publication
(10) Pub. No.: US 2025/0351186 A1
(43) Pub. Date: Nov. 13, 2025

(54) COMMUNICATION APPARATUSES AND COMMUNICATION METHODS FOR MULTI-PRACH TRANSMISSIONS

(71) Applicant: Panasonic Intellectual Property Corporation of America, Torrance, CA (US)

(72) Inventors: Xuan Tuong TRAN, Singapore (SG); Hidetoshi SUZUKI, Kanagawa (JP); Tetsuya YAMAMOTO, Kanagawa (JP); Yoshihiko OGAWA, Kanagawa (JP); Hong Cheng Michael SIM, Singapore (SG); Yang KANG, Singapore (SG)

(21) Appl. No.: 18/859,937

(22) PCT Filed: Apr. 21, 2023
(86) PCT No.: PCT/SG2023/050273

§ 371 Date: Oct. 24, 2024

(30) Foreign Application Priority Data
Apr. 28, 2022 (SG) 10202204592Q

(51) Int. Cl. H04W 74/0833; H04B 17/318; H04W 72/0453

(52) U.S. Cl. CPC H04W 74/0833; H04B 17/328; H04W 72/0453

(57) ABSTRACT

The present disclosure provides communication apparatuses and communication methods for multi-PRACH transmissions. The communication apparatuses include a communication apparatus comprising: a receiver, which in operation, receives control information relating to a multi-PRACH transmission, and a transmitter, which is operation, transmits a multi-PRACH transmission based on the control information, the multi-PRACH transmission comprising a plurality of PRACH transmissions.

### TECHNICAL FIELD

The following disclosure relates to communication apparatuses and communication methods for multi-physical random access channel (multi-PRACH) transmissions, and more particularly to communication apparatuses and communication methods for multi-PRACH transmissions over multiple RACH occasions (ROs) in New Radio (NR).

### BACKGROUND

In current random access channel (RACH) procedure, a user equipment (UE) receives system information block 1 (SIB1) to derive physical random access channel (PRACH) resources indicating RACH occasions (ROs) in time-domain and frequency-domain resources, as well as synchronization signal/PBCH block (SSB) to RO (SSB-to-RO) mapping which is a number of SSBs per RO and a number of Preambles R per SSB per RO. After that, the UE selects one RO to transmit a PRACH preamble (aka Msg1 or PRACH transmission), named as single-PRACH transmission, in an initial uplink bandwidth part (UL BWP). Referring to an illustration 600 in FIG. 6 of a typical 4-step random access procedure between a UE and a base station or gNodeB (gNB), a random access preamble (e.g. PRACH preamble) is transmitted from the UE to the gNB at step 602. At step 604, a random access response (RAR) is received by the UE from the gNB. At step 606, the scheduled transmission is transmitted from the UE to the gNB. At step 608, content resolution for the transmission is received by the UE from the gNB. The UE is not allowed to select another PRACH preamble before an expiration of a RAR window for the same transmitting PRACH preamble.

If transmission or reception of the PRACH preamble is unsuccessful, this PRACH preamble can be repeatedly transmitted with a transmit power that is increased between each transmission by a certain configurable offset (i.e., power-ramping) until the UE receives Msg2 (e.g., RAR) from a base station or gNB, or until a configurable maximum number of retransmissions have been carried out, or until the transmit power at UE side reaches a configurable maximum power. In the 2 latter cases, the random-access attempt is declared as a failure.

UL channel performance could be challenging in most scenarios in real deployment. There are also emerging vertical use cases that require UL heavy traffic, e.g., for video uploading or camera surveillance. It was studied to identify that PRACH is one of bottleneck channels in term of coverage performance. However, due to the limited scope of Rel. 17 Coverage Enhancement (CovEnh), PRACH coverage has not been enhanced. A new working item (WI) for further New Radio (NR) CovEnh has been approved in Rel. 18, where one of the main objectives is to specify the following PRACH coverage enhancements (RAN1, RAN2) [RP-213579]:
Implementation of multiple PRACH transmissions with same beams for 4-step RACH procedure; and
studying, and if justified, specifying PRACH transmissions with different beams for 4-step RACH procedure.

The enhancements of PRACH are targeted for Frequency Range 2 (FR2), and can also apply to FR1 when applicable. Further, the enhancements of PRACH are targeting short PRACH formats, and can also apply to other formats when applicable.

However, there has been no discussion on communication apparatuses and methods for multi-PRACH transmissions.

There is thus a need for communication apparatuses and methods that provide feasible technical solutions for multi-PRACH transmissions over multiple ROs in NR. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and methods for multi-PRACH transmissions.

According to a first embodiment of the present disclosure, there is provided a communication apparatus comprising: a receiver, which in operation, receives control information relating to a multi-PRACH transmission, and a transmitter, which is operation, transmits a multi-PRACH transmission based on the control information, the multi-PRACH transmission comprising a plurality of PRACH transmissions.

According to a second embodiment of the present disclosure, there is provided a base station comprising: circuitry, which in operation, generates control information relating to a multi-PRACH transmission; a transmitter, which in operation, transmits the control information to a communication apparatus; and a receiver, which in operation, receives the multi-PRACH transmission from the communication apparatus.

According to a third embodiment of the present disclosure, there is provided a communication method comprising: receiving control information relating to a multi-PRACH transmission; and transmitting a multi-PRACH transmission based on the control information, the multi-PRACH transmission comprising a plurality of PRACH transmissions.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 shows an exemplary 3GPP NR-RAN architecture.

FIG. 2 depicts a schematic drawing which shows functional split between NG-RAN and 5GC.

FIG. 3 depicts a sequence diagram for RRC (radio resource control) connection setup/reconfiguration procedures.

FIG. 4 depicts a schematic drawing showing usage scenarios of Enhanced mobile broadband (eMBB), Massive Machine Type Communications (mMTC) and Ultra Reliable and Low Latency Communications (URLLC).

FIG. 5 shows a block diagram showing an exemplary 5G system architecture for V2X communication in a non-roaming scenario.

FIG. 6 shows an example illustration of a 4-step random access procedure.

FIG. 7 shows an example illustration of PRACH preamble detection from multi-PRACH transmissions in time-domain.

FIGS. 8A and 8B shows illustrations of multi-PRACH transmissions for different coverage enhancement (CE) levels according to an embodiment E1.

FIG. 9 shows an illustration of multi-PRACH transmissions for different CE levels according to a variation of an embodiment E1.

FIG. 10 shows an illustration of multi-PRACH transmissions for different CE levels according to another variation of an embodiment E1.

FIG. 11A shows an example illustration of higher-layer parameters indicating ROs for multi-PRACH transmissions according to an embodiment E2.

FIG. 11B shows an illustration of Table 6.3.3.2-3 (Random access configurations for FR1 & unpaired spectrum) of TS 38.211 that is enhanced to indicate ROs for multi-PRACH transmissions according to an embodiment E2.

FIG. 12 shows an illustration of how PRACH preambles may be partitioned according to various embodiments.

FIG. 13 shows an illustration of how frequency partitioning may be utilized according to various embodiments.

FIG. 14 shows an illustration of an initial uplink bandwidth part (UL BWP) for reduced capacity (RedCap) UEs and an initial UL BWP for non-RedCap UEs according to an example.

FIG. 15 shows an illustration of a cross-division duplex (XDD) operation according to an example.

FIG. 16 shows an illustration of reduced frequency resource allocation per RO for XDD operation according to an embodiment E3.

FIG. 17 shows an illustration of reduced frequency resource allocation per RO for RedCap UE according to an embodiment E3.

FIG. 18 shows an illustration of SSB-to-RO mapping for RedCap UE or XDD operation according to a variation of an embodiment E3.

FIGS. 19A and 19B show illustrations of increased time-domain ROs for RedCap UE according to a variation of an embodiment E3.

FIG. 20A shows an example flowchart for UE operation configured with a multi-PRACH transmission pattern according to an embodiment E1.

FIG. 20B shows a flowchart for UE operation according to an embodiment E2.

FIG. 20C shows a flowchart for RedCap UE operation according to an embodiment E3.

FIG. 21 shows a flow diagram illustrating a communication method according to various embodiments.

FIG. 22 shows a schematic example of a communication apparatus in accordance with various embodiments.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Some embodiments of the present disclosure will be described, by way of example only, with reference to the drawings. Like reference numerals and characters in the drawings refer to like elements or equivalents.

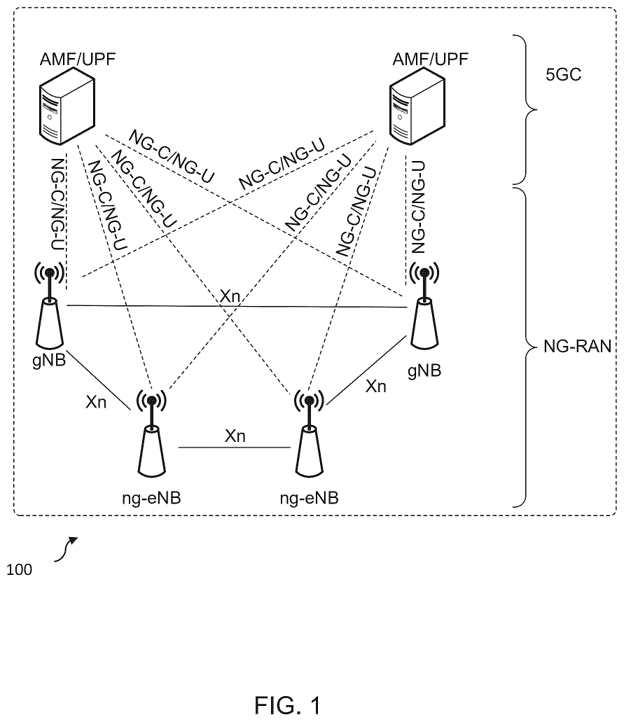

Among other things, the overall system architecture assumes an NG-RAN (Next Generation—Radio Access Network) that comprises gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g. a particular core entity performing the AMF) by means of the NG-C interface and to the UPF (User Plane Function) (e.g. a particular core entity performing the UPF) by means of the NG-U interface. The NG-RAN architecture is illustrated in FIG. 1 (see e.g. 3GPP TS 38.300 v16.3.0, section 4).

The user plane protocol stack for NR (see e.g. 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g. sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300. Further, sidelink communications is introduced in 3GPP TS 38.300 v16.3.0. Sidelink supports UE-to-UE direct communication using the sidelink resource allocation modes, physical-layer signals/channels, and physical layer procedures (see for instance section 5.7 of TS 38.300).

For instance, the Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are PRACH, PUSCH and PUCCH for uplink and PDSCH (Physical Downlink Shared Channel), PDCCH and PBCH (Physical Broadcast Channel) for downlink. Further, physical sidelink channels include Physical Sidelink Control Channel (PSCCH), Physical Sidelink Shared Channel (PSSCH), Physical Sidelink Feedback Channel (PSFCH) and Physical Sidelink Broadcast Channel (PSBCH).

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10⁻⁵ within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g. subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than a mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tᵤ and the subcarrier spacing Δf are directly related through the formula Δf=1/Tᵤ. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v16.3.0).

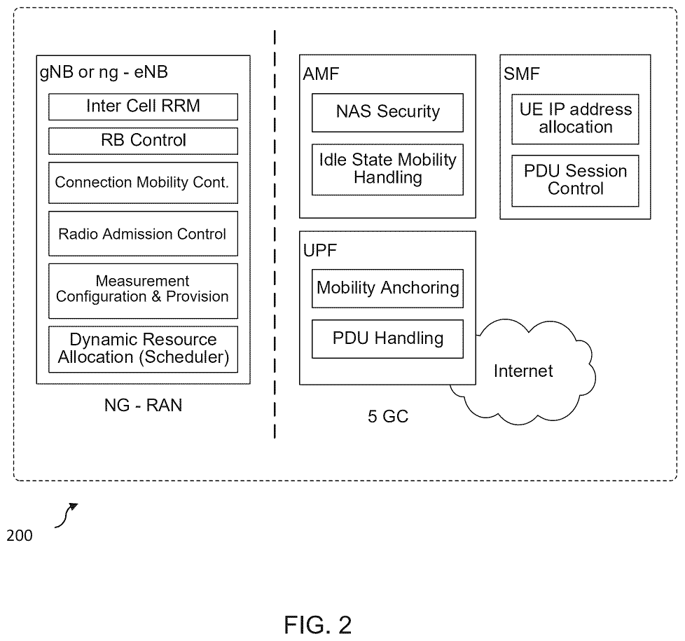

FIG. 2 illustrates functional split between NG-RAN and 5GC. NG-RAN logical node is a gNB or ng-eNB. The 5GC has logical nodes AMF, UPF and SMF.

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signaling termination;
NAS signaling security;
Access Stratum, AS, Security control;
Inter Core Network, CN, node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

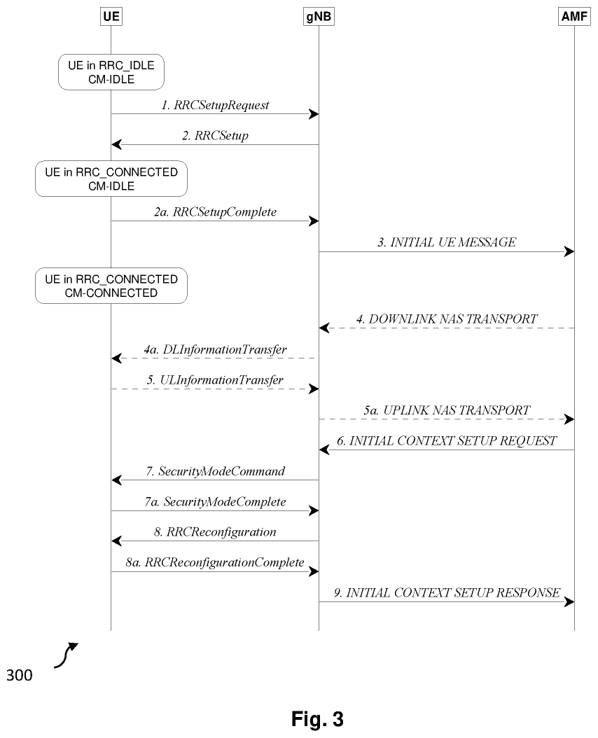

FIG. 3 illustrates some interactions between a UE, gNB, and AMF (an 5GC entity) in the context of a transition of the UE from RRC_IDLE to RRC_CONNECTED for the NAS part (see TS 38.300 v16.3.0). The transition steps are as follows:
1. The UE requests to setup a new connection from RRC_IDLE.
2/2a. The gNB completes the RRC setup procedure.
NOTE: The scenario where the gNB rejects the request is described below.
3. The first NAS message from the UE, piggybacked in RRCSetupComplete, is sent to AMF.
4/4a/5/5a. Additional NAS messages may be exchanged between UE and AMF, see TS 23.502 reference (3GPP TS 23.122: “Non-Access-Stratum (NAS) functions related to Mobile Station in idle mode”).
6. The AMF prepares the UE context data (including PDU session context, the Security Key, UE Radio Capability and UE Security Capabilities, etc.) and sends it to the gNB.
7/7a. The gNB activates the AS security with the UE.
8/8a. The gNB performs the reconfiguration to setup SRB2 and DRBs.
9. The gNB informs the AMF that the setup procedure is completed.

RRC is a higher layer signaling (protocol) used for UE and gNB configuration. In particular, this transition involves that the AMF prepares the UE context data (including e.g. PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

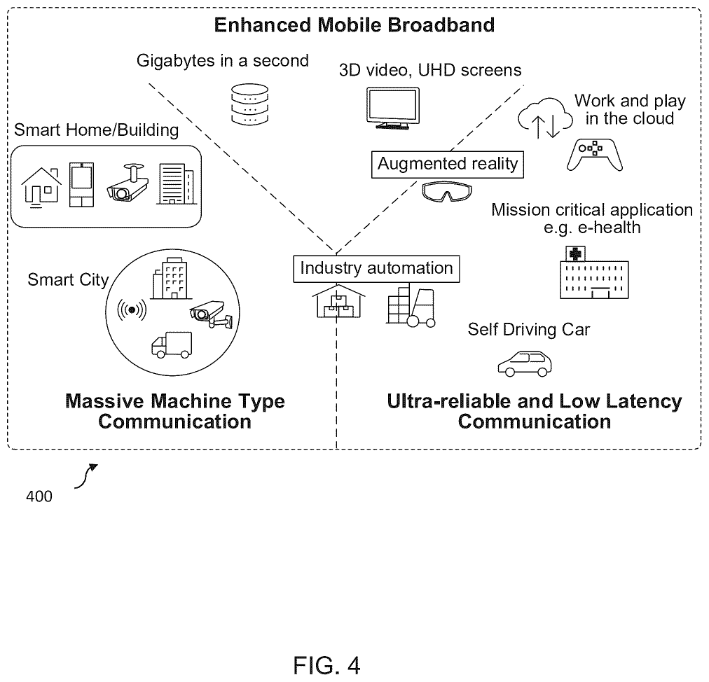

FIG. 4 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications. FIG. 4 illustrates some examples of envisioned usage scenarios for IMT for 2020 and beyond (see e.g. ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, mini-slot-based scheduling with flexible mapping, grant free (configured grant) uplink, mini-slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10⁻⁶ level), higher availability, packet sizes of up to 256 bytes, time synchronization down to the order of a few us where the value can be one or a few us depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g. as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

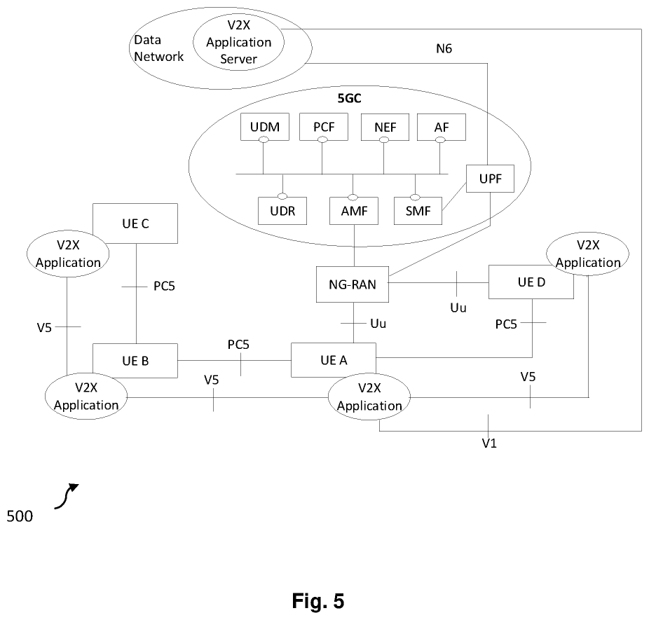

FIG. 5 illustrates a 5G NR non-roaming reference architecture (see TS 23.287 v16.4.0, section 4.2.1.1). An Application Function (AF), e.g. an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g. QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture for V2X communication, namely, Unified Data Management (UDM), Policy Control Function (PCF), Network Exposure Function (NEF), Application Function (AF), Unified Data Repository (UDR), Access and Mobility Management Function (AMF), Session Management Function (SMF), and User Plane Function (UPF) in the 5GC, as well as with V2X Application Server (V2AS) and Data Network (DN), e.g. operator services, Internet access or 3rd party services. All of or a part of the core network functions and the application services may be deployed and running on cloud computing environments.

An issue to be addressed in the present disclosure is that there is no specification on how to perform multi-PRACH transmissions over multiple ROs in NR. If a UE tries to perform a single-PRACH transmission (legacy UE capability) within a slot or multi-PRACH transmissions (Rel. 18 UE capability) over multiple slots by attempting multiple ROs based on the same PRACH resources, gNB does not have knowledge of multi-PRACH transmissions from the UE, so that PRACH detection performance is not desirable.

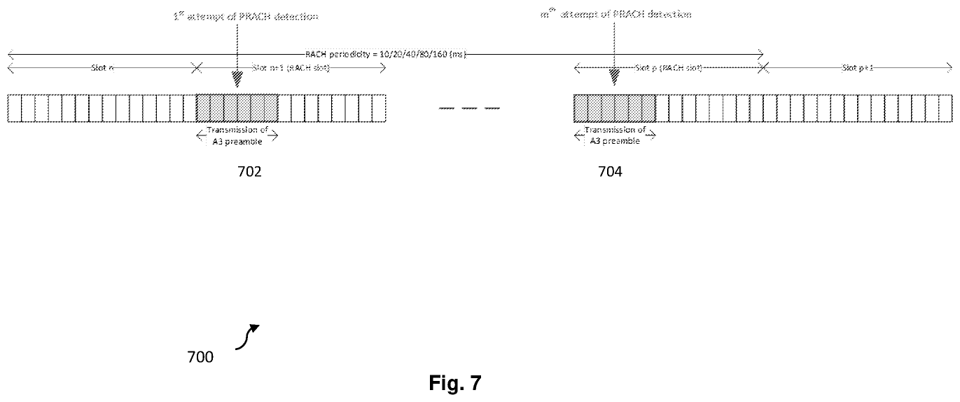

A prior art solution for this issue that is based on top of current PRACH detection for NR specified in TS 38.141-01 is shown in illustration 700 of FIG. 7. Without knowledge of multi-PRACH transmissions, a gNB attempts multiple times (e.g., as shown in first attempt 702 until a m-th attempt 704 of PRACH detection) to detect PRACH preamble from multi-PRACH transmissions in time-domain if the multi-PRACH transmissions are performed by the UE (e.g., to achieve a selective gain in time-domain). From gNB perspective, there is no difference between the PRACH resource of single-PRACH transmission or multi-PRACH transmissions in this solution. The selective gain is reduced, compared to the case of having dedicated multi-PRACH transmission because of near-far problem. A usage of either energy accumulation or coherent accumulation is difficult as it is not clear which PRACH resource corresponding to n-th transmission is used. It is also to be noted that the coherent accumulation requires high gNB complexity.

According to solutions proposed in the present disclosure to address the above-mentioned issue, a UE performs multiple PRACH transmissions based on control information relating to a multi-PRACH transmission pattern (Embodiment E1) or RACH occasions (ROs) of multiple-PRACH transmissions (Embodiment E2). The multi-PRACH transmission pattern or the ROs of the multiple-PRACH transmissions may be different per CE level. When the ROs of the multiple-PRACH transmissions are related by the control information, the multi-PRACH transmission can be implicitly determined from the ROs. To ensure an energy accumulation, PRACH detection of gNB that offers low complexity and reasonable detection gain can be utilized. If UE transmission is specified as coherent multiple PRACH transmission, a coherent accumulation may also be used. If multiple CE levels are configured, the solutions can distinguish the noise level depending on the required number of the PRACH transmissions. The proposed solutions advantageously achieve better performance gain of coverage, as compared to the above-mentioned prior art solution.

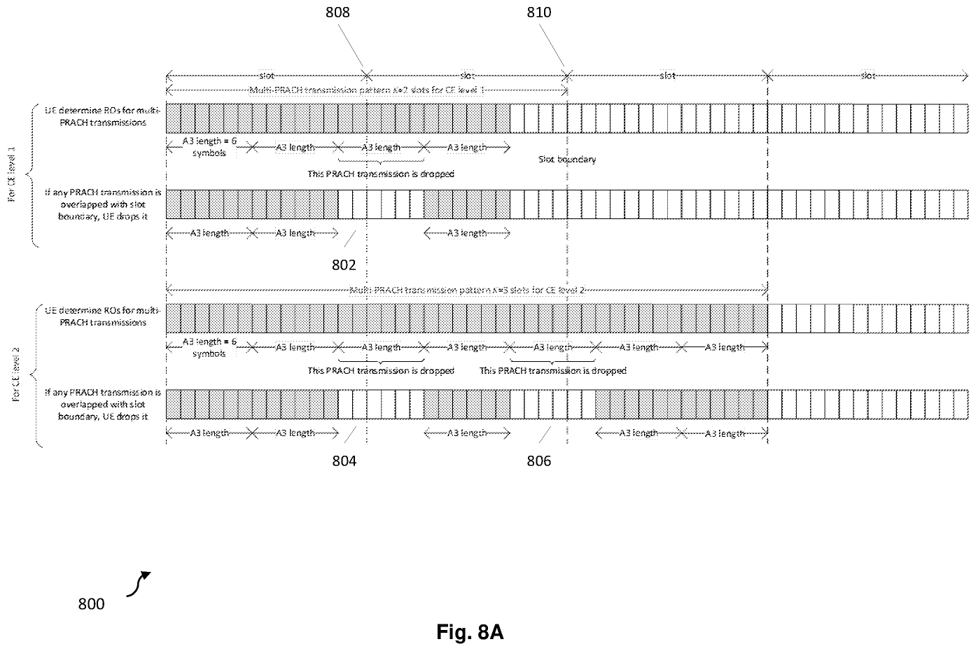

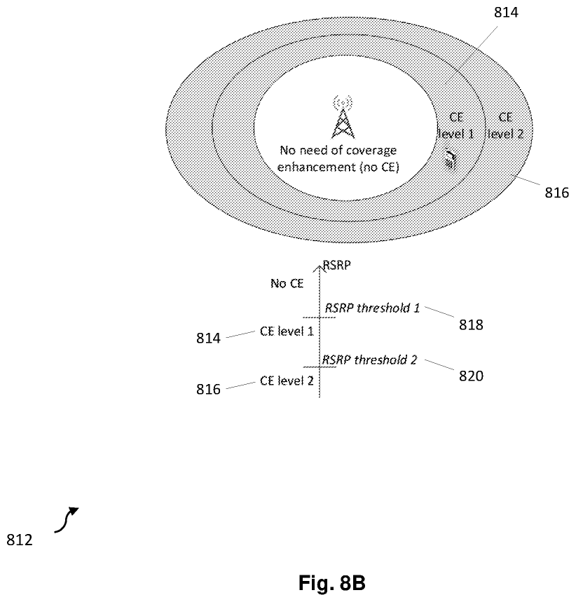

In an embodiment E1, a UE receives a multi-PRACH transmission pattern (K≥1 slots) per CE level to derive RACH occasion (RO) for each PRACH transmission of multiple PRACH transmissions (e.g., a multi-PRACH transmission) depending on the CE level. The multi-PRACH transmission pattern of each CE level may be different from each other. For example, a multi-PRACH transmission pattern for a lower CE level (e.g., CE level 1) may comprise less ROs for transmission than a multi-PRACH transmission pattern for a higher CE level (e.g., CE level 2). Referring to illustrations 800 and 812 of FIGS. 8A and 8B, it is assumed that l₀=0 (e.g. l₀ of formula lᵢ=l₀+iN_{dur}^{RA} for deriving starting position lᵢ of ROs as further explained in the paragraphs below) and an A3 preamble with a length of 6 symbols are used, K=2 slots for CE level 1 (see reference 814), and K=3 slots for CE level 2 (see reference 816).

Due to overlapping with a slot boundary (e.g., a boundary between two slots as shown in references 808 and 810), UE may drop 1 PRACH transmission 802 for CE level 1, and 2 PRACH transmissions 804 and 806 for CE level 2. It is beneficial for a purpose of interaction with frequency hopping (FH) based on slot-level; or for a case when the UE can be configured to accommodate power control command at the beginning of a slot by gNB; or for a flexible case when the UE can be configured to monitor and/or receive PDCCH at the beginning symbol(s) of a slot by gNB.

It will be appreciated that, instead of using a terminology of “a multi-PRACH transmission per CE level”, there could be a multi-PRACH transmission per a number of repetitions of PRACH transmissions, or per one or more Reference Signal Receive Power (RSRP) threshold (e.g., as shown in RSRP threshold 1 818 and RSRP threshold 2 820), or per another criterion that may be configured by an associated gNB.

According to variations of embodiment E1, based on K slots, a UE may be configured to derive RO for each of multiple PRACH transmissions including PRACH duration in symbol unit

$${N}_{dur}^{RA}$$

(i.e., a duration length of each of multiple PRACH transmissions depending on PRACH preamble format), and a starting position. The starting position may be based on one of the following alternatives.

In an alternative 1.1, the starting position of RO—for each of the multiple PRACH transmissions is derived by confining the multiple PRACH transmissions within K slots, for example as shown in FIG. 8A. It can be expressed as

$${l}_{i} = {l}_{0} + {iN}_{dur}^{RA} ,$$

0≤i≤I−1, where

$$I = ⌊ \frac{14 K}{{N}_{dur}^{RA}} ⌋ ,$$

N_{dur}^{RA} and l₀ are specified in TS 38.211. A number of PRACH transmissions per slot may be the same or different among one another.

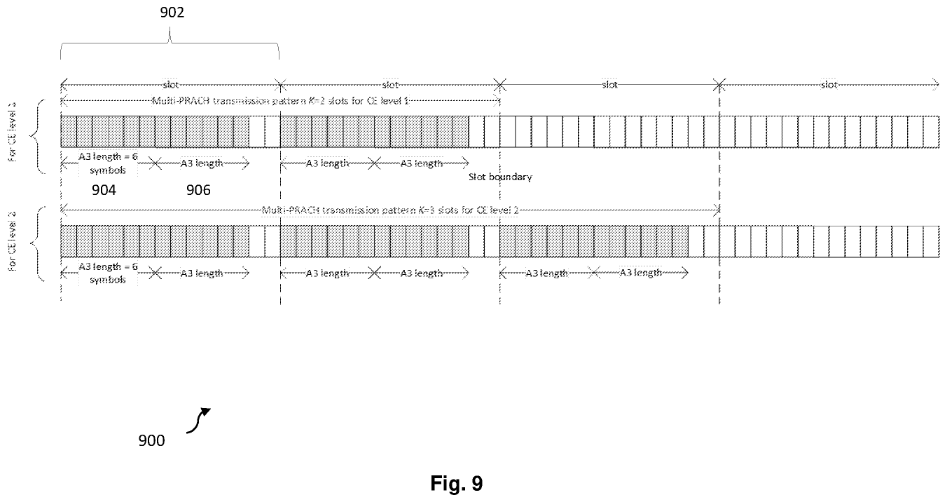

In another alternative 1.2, in the first slot within K slots, the starting positions of ROs of a subset of the multiple PRACH transmissions are derived by confining them within the first slot. These starting positions of ROs are repeated in the remaining (K−1) slots, such as shown in illustration 900 of FIG. 9. Assuming l₀=0 and A3 preamble with a length of 6 symbols, K=2 slots for CE level 1, and K=3 slots for CE level 2, in the first slot 902 within K slots, 2 PRACH transmissions 904 and 906 are defined, and they are repeated in the following (K−1) slots. In this alternative, it can be expressed as

$${l}_{i} = {l}_{0} + {iN}_{dur}^{RA}$$

and Σᵢlᵢ≤14, 0≤i≤I−1, where

$$I = ⌊ \frac{14}{{N}_{dur}^{RA}} ⌋ ,$$

N_{dur}^{RA} and l₀ are specified in technical specification (TS) 38.211. Further, a number of PRACH transmissions per slot is the same.

In further variations of embodiment E1, within K slots, one or more smaller sub-patterns can be determined based on one or a combination of the following. Firstly, in an alternative 2.1, for collision handling between the derived ROs of one or more PRACH transmissions that are overlapped with slot boundary and/or signal (or channels) with different priority, the UE may drop the overlapped one or more PRACH transmissions only, while it keeps the remaining ones to be transmitted. The signal (or channels) with different priority can refer to a downlink reception or uplink transmission with higher priority (such as reception of SSB or reception of PDCCH for URLLC service). Within the multi-PRACH transmission pattern, a number of PRACH transmissions per slot can be the same or different among one another (e.g., an example of using both alternatives 1.1 and 2.1 as shown in illustration 800 of FIG. 8A for collision handling with slot boundary). Advantageously, this is beneficial for a purpose of interaction with frequency hopping (FH) based on slot-level, i.e., a multi-PRACH transmission pattern can include multiple FH hops, and the coherent PRACH detection can be performed per FH hop for a frequency selective gain.

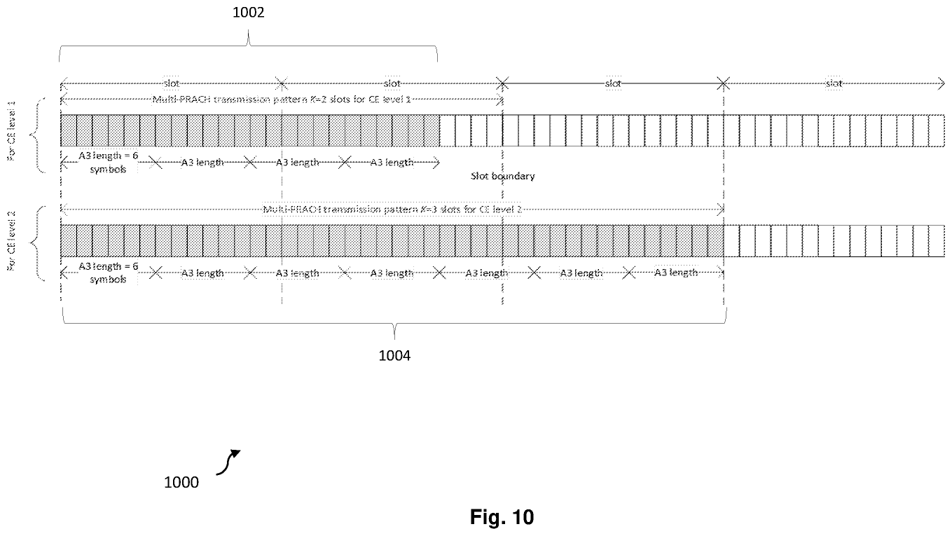

In another alternative 2.2, for collision handling between the derived ROs of one or more PRACH transmissions with slot boundary and/or signal (or channels) with different priority, the UE may generate a PRACH preamble for each of the one or more PRACH transmissions, and it transmits all PRACH transmissions of the multiple PRACH transmissions. An example of using both alternatives 1.1 and 2.2 is shown in illustration 1000 of FIG. 10 for collision handling with slot boundary. For example, referring to illustration 1000, it is assumed that l₀=0 and A3 preamble with a length of 6 symbols are used, K=2 slots for CE level 1, and K-3 slots for CE level 2. The UE performs 4 PRACH transmissions 1002 and 7 PRACH transmissions 1004 for CE level 1 and CE level 2, respectively. Advantageously, this enables the UE to have more possible opportunities of PRACH transmissions within K slots for a better gain of detection. Secondly, a maximum duration of UE capability is also utilized for maintaining phase continuity and power consistency.

In an embodiment E2, a UE may be configured to receive an indication indicating ROs of multiple PRACH transmissions. Upon receiving the indication, UE determines multiple ROs for multi-PRACH transmissions based on legacy procedure. In this case, the multi-PRACH transmission pattern is implicitly determined from the indicated ROS.

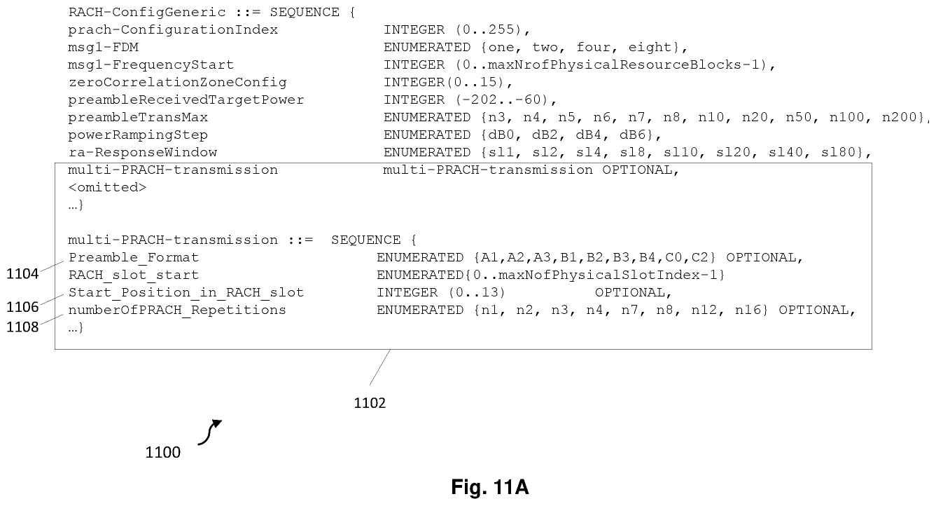

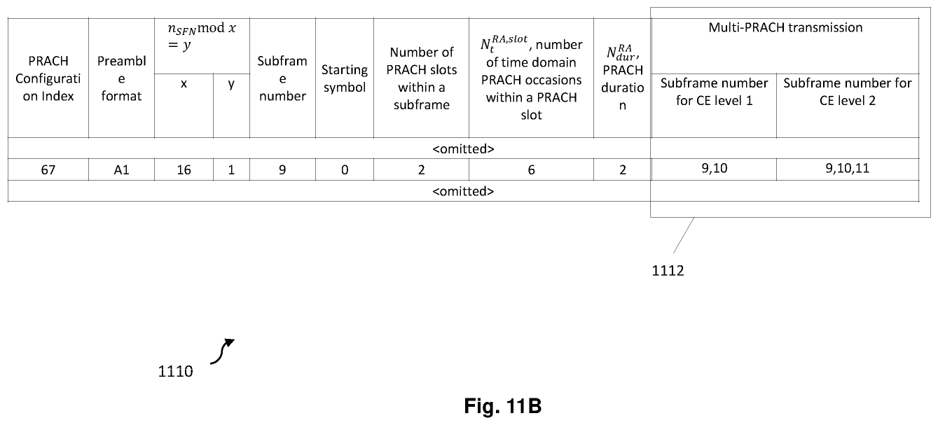

There may be various ways for signalling for the indication. In an option 1, the indication may be by higher-layer parameters in master information block (MIB) and/or system information block (SIB). FIG. 11A shows an example illustration 1100 of higher-layer parameters indicating ROs for multi-PRACH transmissions according to embodiment E2. This is an example of higher-layer parameters indicating ROs for multi-PRACH-transmissions (see reference 1102), where PRACH duration depends on Preamble_Format (see reference 1104), starting position of each RO is defined by Start_Position_in_RACH_slot (see reference 1106), and a number of PRACH transmissions is obtained by numberOfPRACH_Repetitions (see reference 1108). In an option 2, a table-based indication may be used, wherein current tables for random-access configurations are enhanced by adding new entries to indicate ROs for multi-PRACH transmission. The enhanced tables can be configured or pre-configured such as shown in table 1110 of FIG. 11B, which is an example of Table 6.3.3.2-3 (Random access configurations for frequency range 1 (FR1) & unpaired spectrum) of TS 38.211 that is enhanced to indicate ROs for multi-PRACH transmissions (see table portion 1112). In table 1110, current higher-layer parameter prach-ConfiguationIndex is reused to indicate a row of the table. UE uses legacy procedure to determine PRACH duration N_{dur}^{RA} and a starting position of each of the multiple ROs. It will be appreciated that options 1 and 2 can also be jointly used to indicate ROs of multiple PRACH transmissions.

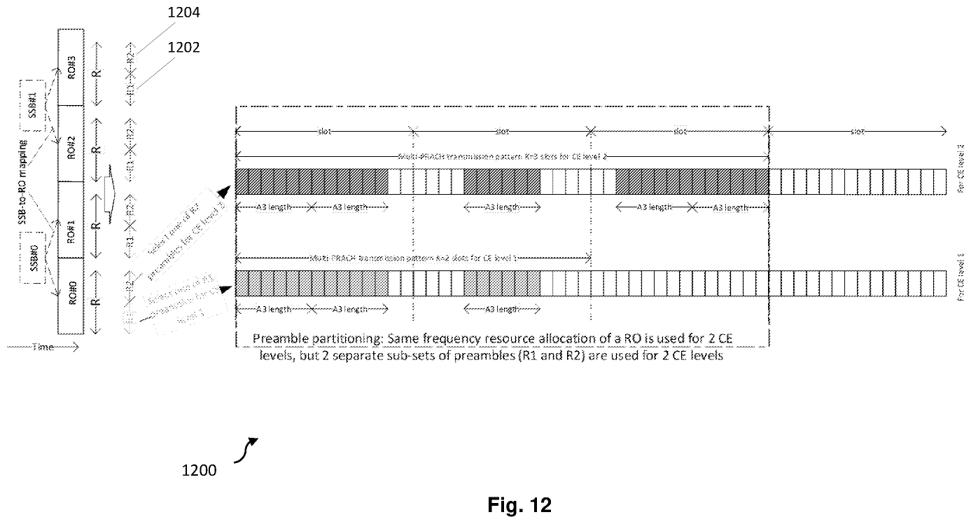

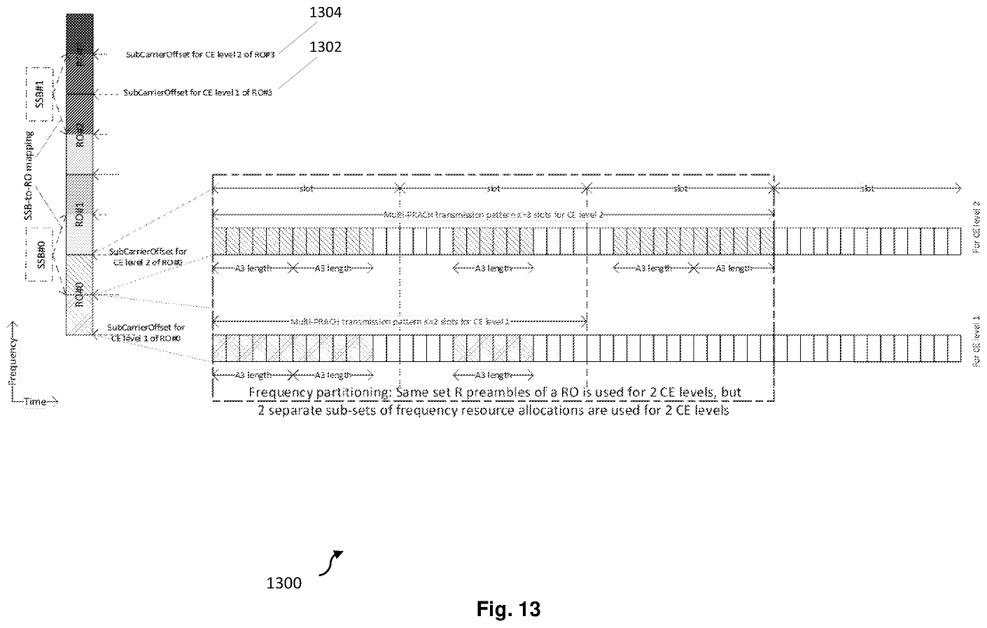

It is also possible to implement common variations for embodiments E1 and E2, wherein the dedicated PRACH resources for multi-PRACH transmissions, which are configured based on CE levels, includes dedicated radio resources and/or PRACH preambles. In an example, illustration 1200 of FIG. 12 shows preamble partitioning for 2 CE levels. Separate R1 and R2 preambles (references 1202 and 1204 respectively) per RO are configured for CE levels 1 and 2, respectively. The UE can use same frequency resource allocation to transmit either one of R1 preambles or one of R2 preambles. In another example, illustration 1300 of FIG. 13 shows to use frequency division multiplexed (FDMed) partitioning for different CE levels per RO, wherein sub-carrier offsets are configured for CE levels 1 and 2, respectively. Same set R preambles of a RO is used for both 2 CE levels, but the UE can use different frequency allocations for different CE levels to select one of R preambles. For example, RO #3 may be configured such that subcarrier offset 1302 will be used for CE level 1, while subcarrier offset 1304 will be used for CE level 2.

Another issue to be addressed in the present disclosure is that it is not specified how multi-PRACH transmissions for UE with different BW capability should be performed yet. Both Embodiments E1 and E2 are not directly applicable for XDD UE and RedCap UE when BW of ROs for multi-PRACH transmissions is wider than the BW configured for XDD and the maximum BW of RedCap UE, respectively.

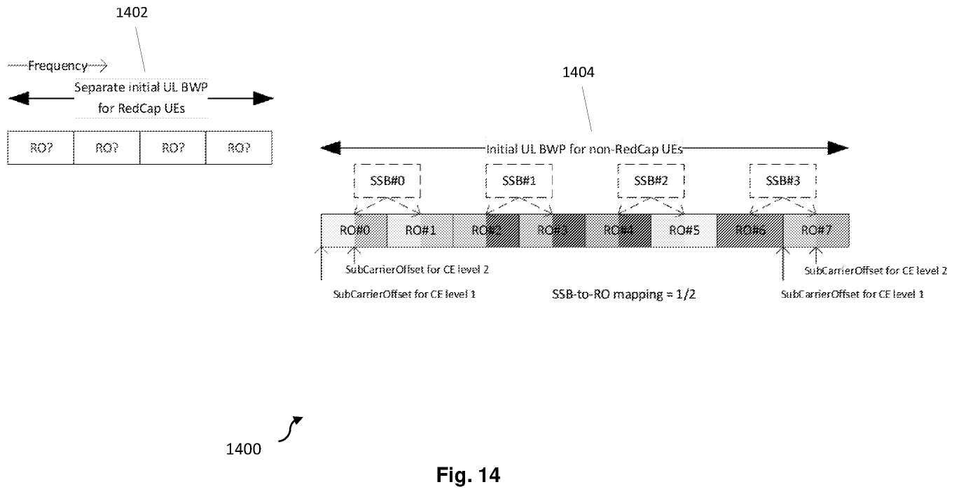

Rel-17 NR supports a reduced capability (RedCap) UEs with the reduced maximum BWs: 20 MHz for FR1 and 100 MHz for FR2. If an initial uplink (UL) bandwidth part (BWP) (e.g., for non-RedCap UEs) is wider than a maximum bandwidth (BW) of RedCap UEs, a separate initial UL BWP (for example, separate UL BWP 1402 is configured for RedCap UEs while separate UL BWP 1404 is configured for non-RedCap UEs in illustration 1400 of FIG. 14) for RedCap UEs within their maximum BW is always configured during initial access. Within the separate initial UL BWP, RO for the RedCap UEs are configured.

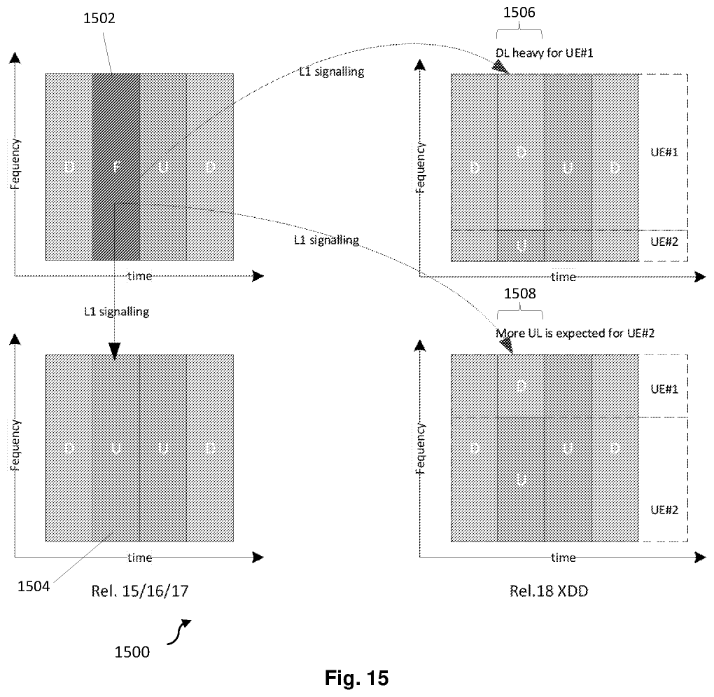

Moreover, a new study item on cross-division duplex (XDD) was approved in RAN #94-e [RP-213591] to investigate the sub-band non-overlapping full duplex (SBFD) and potential enhancements on dynamic/flexible time-division duplex (TDD). In NR, a slot/frame format includes downlink (DL), uplink (UL), and flexible (F) symbol (or slot), where there is a restriction on DL/UL configuration to avoid UL/DL interference among gNB and among UEs, while only F symbol (or slot) can be further configured as either DL symbol (or slot) or UL symbol (or slot) semi-statically or dynamically. For example, referring to illustration 1500 of FIG. 15, in Release 15/16/17, F symbol (or slot) is configured as UL symbol (or slot) (see reference 1504). In XDD, a bandwidth of a plurality of sub-bands (BW_{XDD}), into which a serving cell band is divided, can be configured in the F symbol (or slot) in time-domain because, at F symbol (or slot), several UEs can be further configured as DL, whereas other UEs can be further configured as UL. For example, referring to illustration 1500 of FIG. 15, frequency resource allocations at F symbol (or slot) are configured flexibility for UE #1 and UE #2, for downlink-heavy reception for UE #1 (see reference 1506) and less UL transmission for UE #2; or uplink-heavy transmission for UE #2 (see reference 1508) and less DL reception for UE #1 depending on application. For gNB side, (quasi) full duplex is required, while for UE side, half duplex can be used.

Furthermore, Rel-17 NR supports a reduced capability (RedCap) UEs with the reduced maximum BWs: 20 MHz for FR1 and 100 MHz for FR2. If an initial (uplink) UL bandwidth part (BWP) (e.g., for non-RedCap UEs) is wider than a maximum bandwidth (BW) of RedCap UEs, a separate initial UL BWP (for example, separate UL BWP 1402 is configured for RedCap UEs while separate UL BWP 1404 is configured for non-RedCap UEs in illustration 1400 of FIG. 14) for RedCap UEs within their maximum BW is always configured during initial access. Within the separate initial UL BWP, RO for the RedCap UEs are configured.

Moreover, a new study item on cross-division duplex (XDD) was approved in RAN #94-e [RP-213591] to investigate the sub-band non-overlapping full duplex (SBFD) and potential enhancements on dynamic/flexible time-division duplex (TDD). In NR, a slot/frame format includes downlink (DL), uplink (UL), and flexible (F) symbol (or slot), where there is a restriction on DL/UL configuration to avoid UL/DL interference among gNB and among UEs, while only F symbol (or slot) can be further configured as either DL symbol (or slot) or UL symbol (or slot) semi-statically or dynamically. For example, referring to illustration 1500 of FIG. 15, in Release 15/16/17, F symbol (or slot) is configured as UL symbol (or slot) (see reference 1504). In XDD, a bandwidth of a plurality of sub-bands (BW_{XDD}), into which a serving cell band is divided, can be configured in the F symbol (or slot) in time-domain because, at F symbol (or slot), several UEs can be further configured as DL, whereas other UEs can be further configured as UL. For example, referring to illustration 1500 of FIG. 15, frequency resource allocations at F symbol (or slot) are configured flexibility for UE #1 and UE #2, for downlink-heavy reception for UE #1 (see reference 1506) and less UL transmission for UE #2; or uplink-heavy transmission for UE #2 (see reference 1508) and less DL reception for UE #1 depending on application. For gNB side, (quasi) full duplex is required, while for UE side, half duplex can be used.

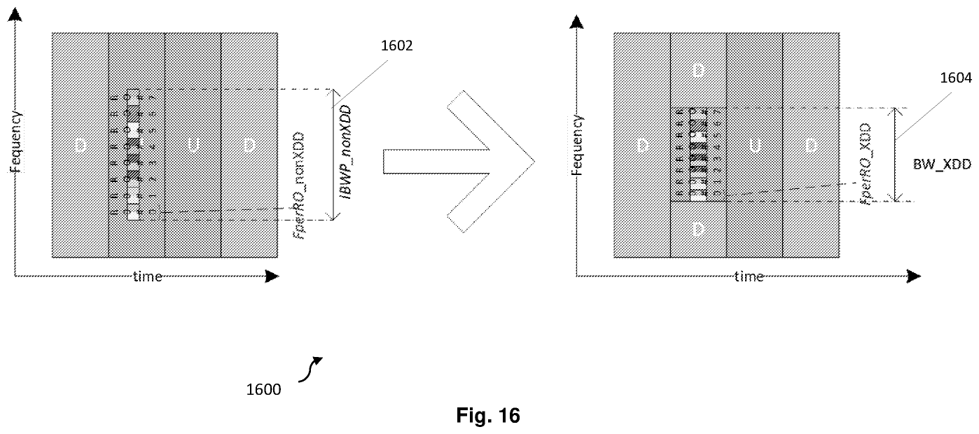

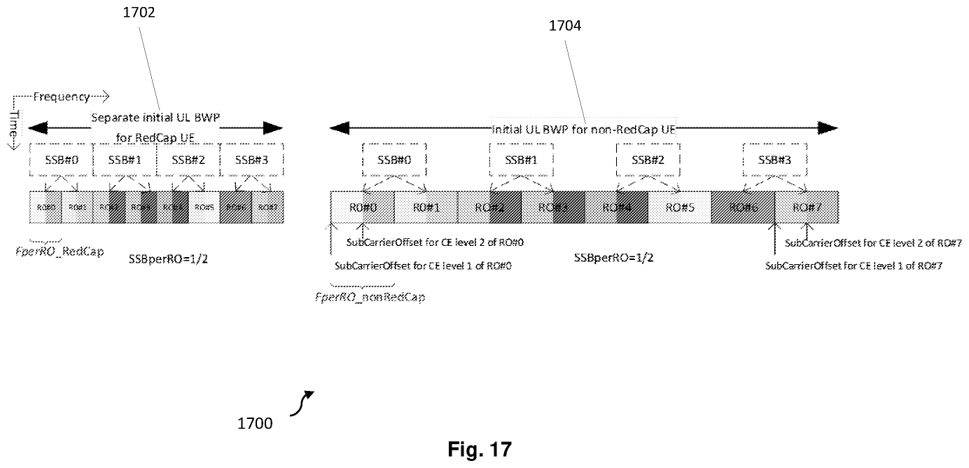

In an embodiment E3, less frequency resource allocation per RO for multi-PRACH transmissions or lesser frequency resource allocations of all ROs is configured to a UE according to one of the following conditions:
A bandwidth of a plurality of sub-bands (BW_{XDD}), into which a serving cell band is divided, is narrower than a threshold (e.g., for a UE operating in SBFD/XDD as shown in illustration 1600 of FIG. 16).
A first UL band of SBFD/XDD which is narrower than a second UL band of SBFD/XDD.
A maximum bandwidth of the UE is narrower than a threshold (e.g., for RedCap UE as shown in illustration 1700 of FIG. 17, wherein a separate initial UL BWP of RedCap is configured within the maximum bandwidth of the RedCap UE. Within the separate initial UL BWP, RO for the RedCap UEs are determined)

The threshold can be a configured initial UL BWP. Further, the configured initial BWP can be replaced by resource block (RB) set, sub-band set where a serving cell band is divided, a whole bandwidth of ROs frequency division multiplexed (FDMed) in one time instance configured currently by higher layer parameter msg1-FDM, or another value configured by gNB. Advantageously, the solutions proposed according to embodiment E3 improves coverage performance of UEs with different BW capability. It will be appreciated that UL BWP and UL band may be used interchangeably.

In an example according to FIG. 16, the lesser frequency resource allocations of all ROs are confined within BW_{XDD} in time-domain. For example, the less frequency resource allocation per RO is determined based on a function of BW_{XDD} in time-domain. The function may be expressed as

$${FperRO}_{XDD} = {FperRO}_{nonXDD} \times \frac{{BW}_{XDD}}{{iBWP}_{nonXDD}} ,$$

where FperRO_{nonXDD} is bandwidth of RO for non-XDD UE and iBWP_{nonXDD} is the configured initial UL BWP for non-XDD UE. Referring to FIG. 16, iBWP_{nonXDD} 1604 will generally have more BW than BW_{XDD} 1604. It can be applicable when time domain resource includes semi-static flexible symbols/slots. For simplicity, a same value of BW_{XDD} can also be applied for a set of consecutive flexible and/or uplink slots.

Alternatively, there is two or more than two bandwidth of UL band in XDD, as shown in right Figure of FIG. 16. For example, a first UL band with BW_XDD (i.e., at second time symbol/slot) is narrower than a second UL band (i.e., at third time symbol/slot). In the case, the lesser frequency resource of all ROs are allocated for the first UL band (at the second time symbol/slot), and the more frequency resource of all ROs are allocated for the second UL band (at the third time symbol/slot).

If an initial UL BWP of non-RedCap UE is wider than a maximum BW of RedCap UEs, a separate initial UL BWP for RedCap UEs within their maximum BW is configured during initial access. Within the separate initial UL BWP (instead of within the initial UL BWP of non-RedCap UE), RO for RedCap is determined. In an example according to FIG. 17, the lesser frequency resource allocations of all ROs are confined within the separate initial UL BWP for RedCap UE. It can be expressed as

$${FperRO}_{RedCap} = {FperRO}_{nonRedCap} \times \frac{{siBWP}_{RedCap}}{{iBWP}_{nonRedCap}} ,$$

where FperRO_{RedCap} and FperRO_{nonRedCap} are bandwidths of ROs for RedCap UE and non-RedCap UE in a time instance, respectively, siBWP_{RedCap} is the separate initial UL BWP for RedCap UE, and iBWP_{RedCap} is the initial UL BWP for non-RedCap UE. Sub-carrier offset for RedCap UE SubcarrierOffset_CE(i, j)_{RedCap} can be separately configured or implicitly derived from that of for non-RedCap UE SubcarrierOffset_CE(i, j)_{nonRedCap}. SSB-to-RO mapping for RedCap UE is the same as for non-RedCap UE. For example, referring to FIG. 17, while separate initial UL BWP 1702 for RedCap UE has less frequency resource allocation than initial UL BWP 1704 for non-RedCap UE, both BWPs have the same SSB-to-RO mapping of ½.

Therefore, if an initial UL BWP for non-RedCap UE is not wider than a maximum BW of RedCap UEs, either embodiment E1 or embodiment E2 may be used to determine ROs for multi-PRACH transmission for RedCap UE as same as that for non-RedCap UE. If an initial UL BWP for non-RedCap UE is wider than a maximum BW of RedCap UEs, embodiment E3 may be used to determine ROs for multi-PRACH transmission for RedCap UE in a separate initial UL BWP, but either embodiment E1 or embodiment E2 is used to determine ROs for multi-PRACH transmission for non-RedCap UE in initial UL BWP.

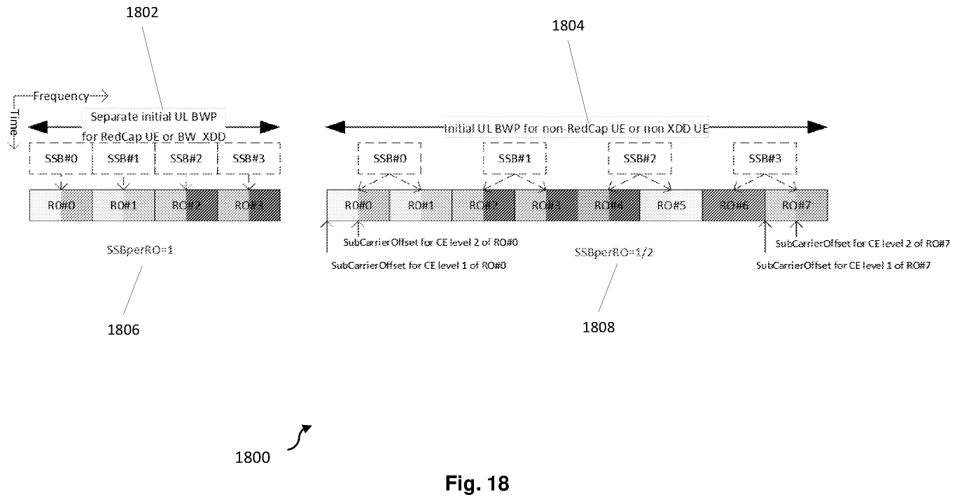

In a variation of embodiment E3, different SSB-to-RO mapping is proposed to the UE instead. For example, referring to illustration 1800 of FIG. 18, SSB-to-RO mapping 1806 is 1 (e.g., each SSB is mapped to 1 RO) for initial UL BWP 1802 for RedCap UE or a small uplink band of a XDD UE, while SSB-to-RO mapping 1808 is ½ (e.g., each SSB is mapped to 2 ROs) for initial UL BWP 1804 for non-RedCap UE or a large uplink band of a XDD UE (e.g., legacy UE or normal Release 15/16/17 UE).

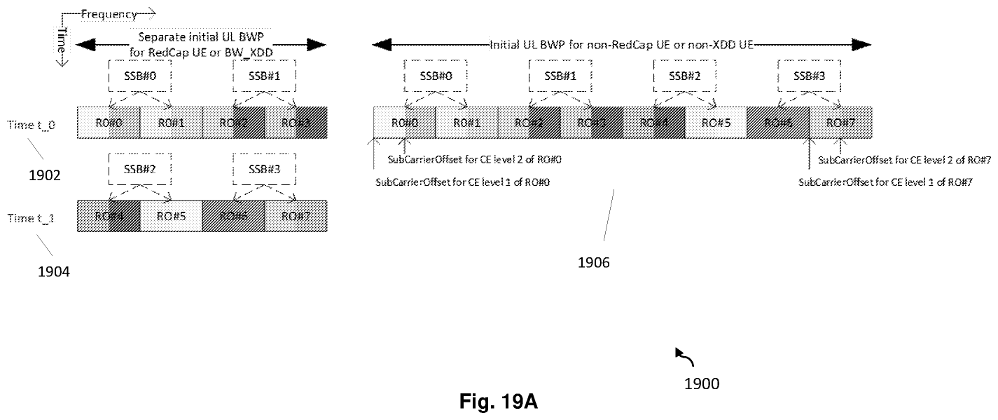

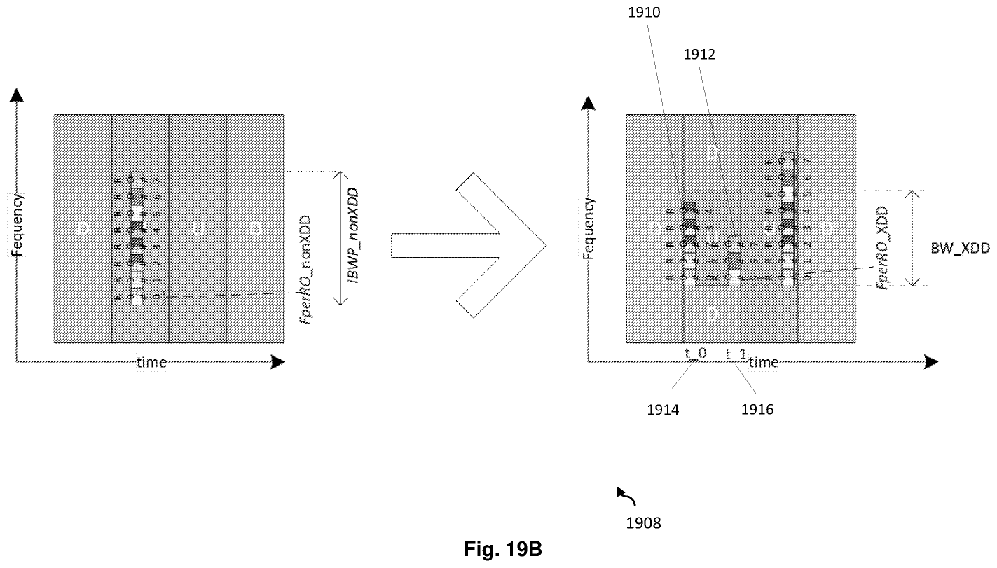

Alternatively, more time-domain RO is proposed to the UE instead. Referring to illustration 1900 of FIG. 19A, multi-PRACH transmission is done by RedCap UE at time instance t_0 (see reference 1902) and t_1 (see reference 1904), while it is done by non-RedCap UE at time instance t_0 (see reference 1906). This advantageously provides more time of processing for RedCap UE transmissions as it has limited capability, as compared with non-RedCap UE. In addition, it allows RedCap UE to change direction in a coarse manner in time-domain by using hybrid or analog beamforming such that a finer beam can be done within the coarse direction in frequency-domain to transmit preamble, e.g., a first coarse direction includes SSB #0 and SSB #1 beams at t_0, a second coarse direction includes SSB #2 and SSB #3 beams at t 1. That might provide a better reception of gNB.

Furthermore, in another variation of embodiment E3, the number of ROs among each time instance (e.g., symbol/slot at t_0 and t_1 as discussed above, or the second time symbol/slot and the third time symbol/slot as discussed above) may be configured to be different. For example, referring to illustration 1908 in FIG. 19B, due to the threshold, all ROs cannot be confined within the bandwidth of a plurality of sub-bands BW_{XDD} or a separate initial UL BWP for RedCap UE. A subset of ROs (such as RO #0, RO #1, RO #2, RO #s3, and RO #4 as shown in RO subset 1910), of which their bandwidth is confined within the bandwidth of a plurality of sub-bands BW_{XDD} or a separate initial UL BWP for RedCap UE, are transmitted at t_0. Meanwhile, the remaining ROs (such as RO #5, RO #6, and RO #7 as shown in RO subset 1912) are transmitted at t_1 1916.

Alternatively, the number of ROs may be small in a small UL (sub-)band in XDD in a time symbol/slot, and the number of ROs may be large in a large UL (sub-)band in XDD in a time symbol/slot. As one example, the ROs may be distributed to more time symbols/slots in a small UL (sub-)band in XDD compared to that in a large UL (sub-)band in XDD. For example, a subset of ROs (such as RO #0, RO #1, RO #2, RO #s3, and RO #4 in RO subset 1910), of which their bandwidth is confined within the small UL (sub-)band, are transmitted at t_0 1914 in the small UL (sub-)band in XDD. Meanwhile, the remaining ROs (such as RO #5, RO #6, and RO #7 in RO subset 1912) are transmitted at t_1 1916 in the small UL (sub-)band in XDD.

Further, the SSB-to-RO mapping may be same or different among a small UL (sub-)band and a large UL (sub-)band. Alternatively, SSB-to-RO mapping of the small UL (sub-)band may be same as SSB-to-RO mapping of a part of the large UL (sub-)band. The part of the large UL band may be same frequency as the small UL (sub-)band. SSB-to-RO mapping of the other part of the large UL (sub-)band may be dropped or may not be defined in the small UL (sub-)band.

In all embodiments E1 to E3, during a multi-PRACH transmission pattern, a UE may be configured to keep maintaining power consistency and phase continuity for coherent PRACH detection. Further, the UE may be configured to perform multi-PRACH transmissions by using the same beam, named as PRACH repetition. The PRACH repetition can be used with a power-ramping step based on the following alternatives. In a first alternative, PRACH repetition starts only after UE reaches a maximum transmit power. At a maximum transmit power, UE increases a number of PRACH transmissions, which is configurable, to be transmitted. The process fails if a number of PRACH repetitions reaches a maximum value and there is still no response from gNB. In a second alternative, PRACH repetition starts before UE reaches a maximum transmit power. For example, at a transmit power pᵢ, UE increases a number of PRACH transmissions, which is configurable, to be transmitted. If unsuccessful, UE transmits a number of PRACH transmissions with a power-ramping step pᵢ=pᵢ+Δ, where Δ is configurable. The process is failed if the transmit power reaches a maximum value and there is still no response from gNB.

In all embodiments, during a multi-PRACH transmission pattern, a UE may be configured to perform multi-PRACH transmissions by using different beams, named as “PRACH sweeping”. The UE sweeps different beams for multiple PRACH transmissions in order to find a best narrower Tx beam pair before any RRC configuration. The UE does not maintain power consistency and phase continuity during a multi-PRACH transmission pattern. Following that, an associated gNB just performs power combining among the PRACH transmissions, and the gNB indicates a best narrower Tx beam index in Msg2 to be used by the UE for the following steps for PRACH procedures, i.e., Msg3 transmission.

In all embodiments, a multi-PRACH transmission pattern also means a multi-PRACH transmission window/duration/period.

In all embodiments, a combination of preamble formats (e.g., formats A and B) can be used within a multi-PRACH transmission pattern in order to utilize the time-domain resource.

In all embodiments, energy accumulation combining can be used at gNB. In this case, the UE is then not required to have coherent multiple PRACH transmissions.

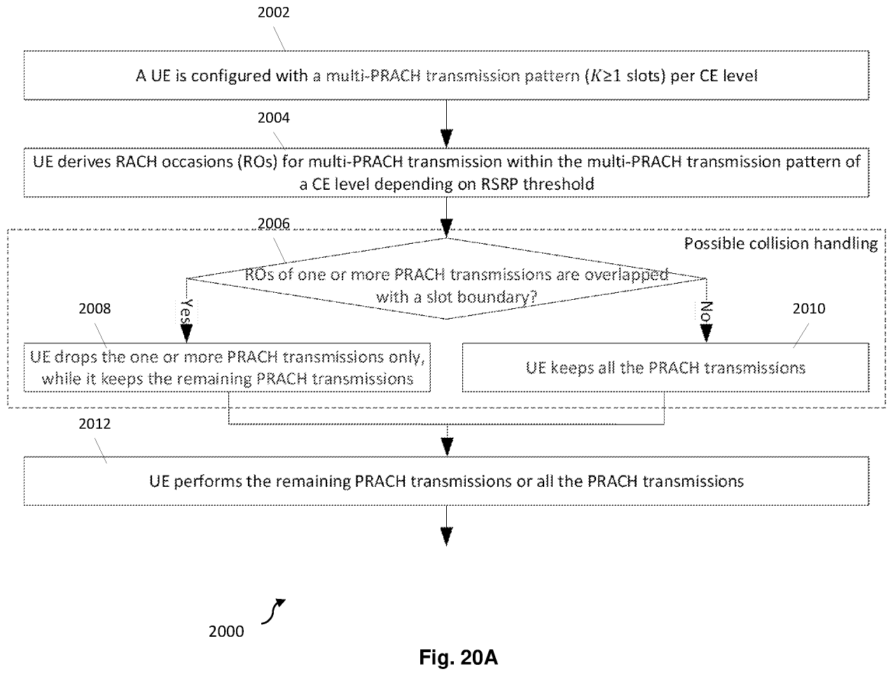

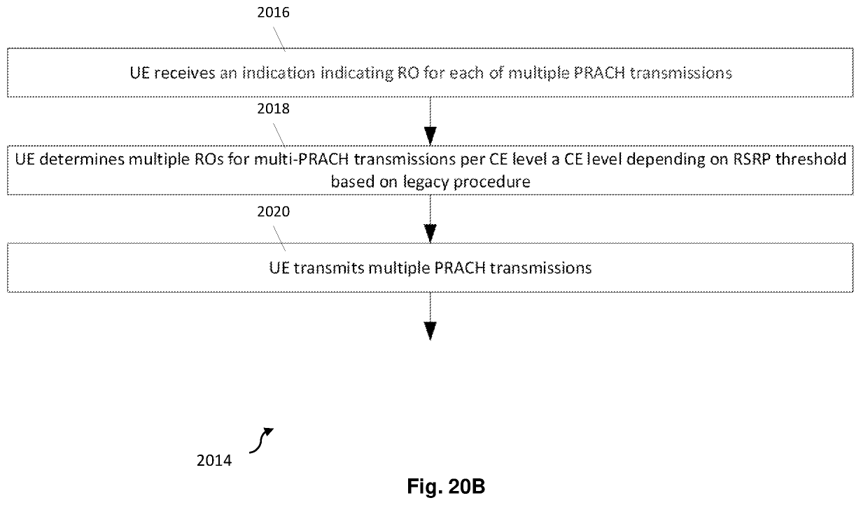

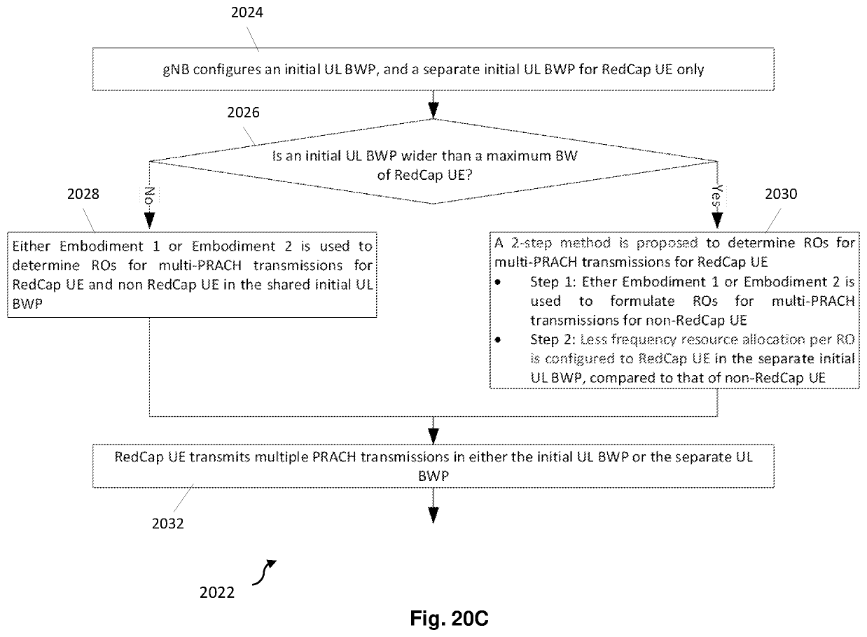

FIG. 20A shows an example flowchart for UE operation configured with a multi-PRACH transmission pattern according to embodiment E1. At step 2002, a UE is configured with a multi-PRACH transmission pattern (K≥1 slots) per CE level. At step 2004, the UE derives RACH occasions (ROs) for multi-PRACH transmission pattern of a CE level depending on RSRP threshold. At step 2006, it is determined whether ROs of one or more PRACH transmissions are overlapped with a slot boundary. If it is determined to be the case, the process proceeds to step 2008 where the UE drops the one or more PRACH transmissions only, while it keeps the remaining PRACH transmissions. Otherwise, the process proceeds to step 2010 instead where the UE keeps all the PRACH transmissions. The process then proceeds to step 2012 where the UE performs the remaining PRACH transmissions or all the PRACH transmissions of the multi-PRACH transmission.

FIG. 20B shows a flowchart for UE operation according to embodiment E2. At step 2016, a UE receives an indication indicating RO for each PRACH transmission of multiple PRACH transmissions (e.g., a multi-PRACH transmission). At step 2018, the UE determines multiple ROs for the multi-PRACH transmissions per CE level, wherein each CE level depends on a RSRP threshold based on legacy procedure. At step 2020, the UE transmits the multiple PRACH transmissions based on the determined multiple ROs.

FIG. 20C shows a flowchart 2022 for RedCap UE operation according to embodiment E3. It is a general flowchart for RedCap UE that is allowed to access to a serving cell depending on the initial UL BWP configured for non-RedCap UE by gNB. At step 2024, gNB configures an initial UL BWP, and a separate initial UL BWP for RedCap UE only. At step 2026, it is determined whether an initial UL BWP is wider than a maximum BW of the RedCap UE. If it is determined to be the case, the process proceeds to step 2030 where a 2-step method is used to determine ROs for multi-PRACH transmissions for the RedCap UE: in step 1, either embodiment E1 or embodiment E2 is implemented to formulate ROs for multi-PRACH transmissions for the non-RedCap UE; in step 2, lesser frequency resource allocation per RO is configured for the RedCap UE in the separate initial UL BWP compared to that for a non-RedCap UE. On the other hand, If it is not determined to be the case at step 2026, the process proceeds to step 2028 instead, where either embodiment E1 or embodiment E2 is used to determine ROs for multi-PRACH transmissions for RedCap UE and non-RedCap UE in the shared initial UL BWP. From either step 2028 or step 2030, the process then proceeds to step 2032 where the RedCap UE transmits multiple PRACH transmissions in either the shared initial UL BWP (from step 2028) or the separate UL BWP (from step 2030).

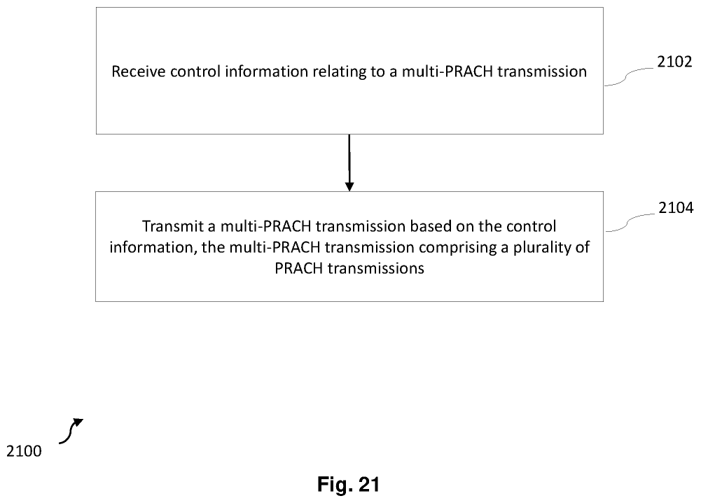

FIG. 21 shows a flow diagram 2100 illustrating a communication method according to various embodiments. In step 2102, control information relating to a multi-PRACH transmission is received. In step 2104, a multi-PRACH transmission is transmitted based on the control information, the multi-PRACH transmission comprising a plurality of PRACH transmissions.

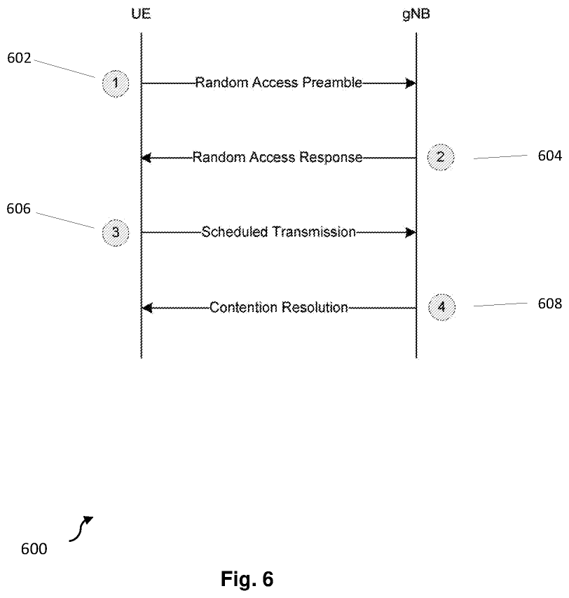

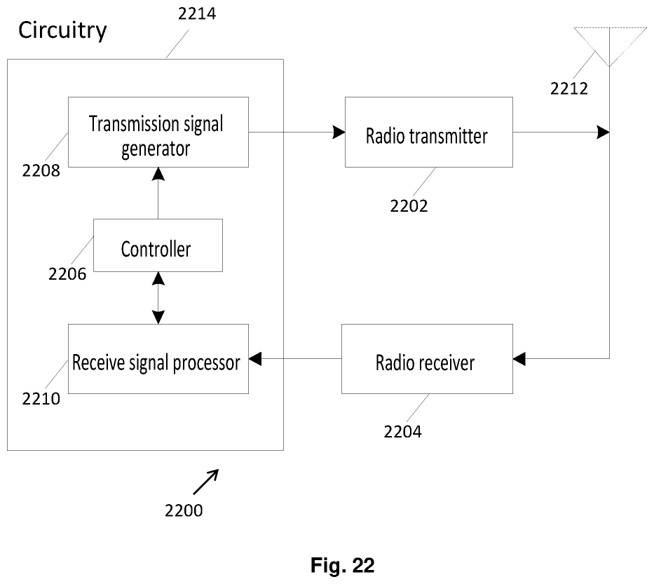

FIG. 22 shows a schematic, partially sectioned view of the communication apparatus 2200 that can be implemented for in accordance with various embodiments and examples as shown in FIGS. 1 to 21. The communication apparatus 2200 may be implemented as a UE or base station according to various embodiments.

Various functions and operations of the communication apparatus 2200 are arranged into layers in accordance with a hierarchical model. In the model, lower layers report to higher layers and receive instructions therefrom in accordance with 3GPP specifications. For the sake of simplicity, details of the hierarchical model are not discussed in the present disclosure.

As shown in FIG. 22, the communication apparatus 2200 may include circuitry 2214, at least one radio transmitter 2202, at least one radio receiver 2204, and at least one antenna 2212 (for the sake of simplicity, only one antenna is depicted in FIG. 22 for illustration purposes). The circuitry 2214 may include at least one controller 2206 for use in software and hardware aided execution of tasks that the at least one controller 2206 is designed to perform, including control of communications with one or more other communication apparatuses in a wireless network. The circuitry 2214 may furthermore include at least one transmission signal generator 2208 and at least one receive signal processor 2210. The at least one controller 2206 may control the at least one transmission signal generator 2208 for generating signals (for example, a signal indicating a geographical zone) to be sent through the at least one radio transmitter 2202 to one or more other communication apparatuses and the at least one receive signal processor 2210 for processing signals (for example, a signal indicating a geographical zone) received through the at least one radio receiver 2204 from the one or more other communication apparatuses under the control of the at least one controller 1506. The at least one transmission signal generator 2208 and the at least one receive signal processor 2210 may be stand-alone modules of the communication apparatus 2200 that communicate with the at least one controller 2206 for the above-mentioned functions, as shown in FIG. 22. Alternatively, the at least one transmission signal generator 2208 and the at least one receive signal processor 2210 may be included in the at least one controller 2206. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 2202, at least one radio receiver 2204, and at least one antenna 2212 may be controlled by the at least one controller 1506.

The communication apparatus 2200, when in operation, provides functions required for multi-PRACH transmissions. For example, the communication apparatus 2200 may be a UE, and the receiver 2204 may, in operation, receive control information relating to a multi-PRACH transmission. The transmitter 2202 may, in operation, transmit a multi-PRACH transmission based on the control information, the multi-PRACH transmission comprising a plurality of PRACH transmissions.

The control information may indicate a multi-PRACH transmission pattern for one or more transmission slots, and the transmitter 2202 may be further configured to transmit the multi-PRACH transmission over the one or more transmission slots based on the multi-PRACH transmission pattern.

The control information may further indicate a different multi-PRACH transmission pattern for each of one or more coverage enhancement (CE) levels, wherein the circuitry 2214 may, in operation, determine a CE level for the multi-PRACH transmission, and wherein the transmitter 2202 may be further configured to transmit the multi-PRACH transmission based on a multi-PRACH transmission pattern that corresponds to the determined CE level.

The control information may further indicate a different number of transmission slots for each of the one or more CE levels, and the transmitter 2202 may be further configured to transmit the multi-PRACH transmission within the number of transmission slots corresponding to the determined CE level.

The circuitry 2214 may, in operation, determine a duration and a starting position for each PRACH transmission of the multi-PRACH transmission within the one or more transmission slots, and the transmitter 2202 may be further configured to transmit the multi-PRACH transmission based on the determined durations and starting positions. The circuitry 2214 may be further configured to determine one or more smaller sub-patterns within the multi-PRACH transmission pattern if a condition is met, wherein the condition is to handle a collision between any PRACH transmission of the multi-PRACH transmission and a slot boundary, and/or a collision between any PRACH transmission of the multi-PRACH transmission and either other uplink transmission or downlink reception with higher priority.

The circuitry 2214 may, in operation, identify one or more PRACH transmissions of the multi-PRACH transmission over one or more slot boundaries of the one or more transmission slots, and the transmitter 2202 may be further configured to transmit the multi-PRACH transmission over the one or more transmission slots without the identified one or more PRACH transmissions.

The circuitry 2214 may, in operation, identify one or more PRACH transmissions of the multi-PRACH transmission over one or more slot boundaries of the one or more transmission slots, and generates a PRACH preamble of each of the multi-PRACH transmission including the one or more identified PRACH transmissions, and the transmitter 2202 may be further configured to transmit the multi-PRACH transmission including transmitting the identified one or more PRACH transmissions over the one or more slot boundaries.

The control information may indicate a plurality of RACH occasions (ROs) for the multi-PRACH transmission, and the transmitter 2202 may be further configured to transmit the multi-PRACH transmission based on the indicated plurality of ROs. The control information may be indicated by one or a combination of a downlink control information, a table-based information, an uplink control information, medium access control control element (MAC CE), or radio resource control (RRC).

The control information may indicate one or more beams for uplink transmission, and the transmitter 2202 may be further configured to transmit a multi-PRACH transmission by using only one of the indicated one or more beams. The control information may indicate one or more beams for uplink transmission, and the transmitter 2202 may be further configured to transmit a multi-PRACH transmission by using a subset of the indicated one or more beams. The transmitter 2202 may be further configured to transmit a multi-PRACH transmission only after the communication apparatus reaches a maximum transmit power.

The communication apparatus 2200 may, for example, be a base station, and the circuitry may, in operation, generate control information relating to a multi-PRACH transmission. The transmitter 2202 may, in operation, transmit the control information to a communication apparatus. The receiver 2204 may, in operation, receive the multi-PRACH transmission from the communication apparatus.

### (Control Signals)

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the 1st stage sidelink control information (SCI) or the 2nd stage SCI.

### (Base Station)

In the present disclosure, the base station may be a Transmission Reception Point (TRP), a clusterhead, an access point, a Remote Radio Head (RRH), an eNodeB (eNB), a gNodeB (gNB), a Base Station (BS), a Base Transceiver Station (BTS), a base unit or a gateway, for example. Further, in side link communication, a terminal may be adopted instead of a base station. The base station may be a relay apparatus that relays communication between a higher node and a terminal. The base station may be a roadside unit as well.

### (Uplink/Downlink/Sidelink)

The present disclosure may be applied to any of uplink, downlink and sidelink.

The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

### (Data Channels/Control Channels)

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

### (Reference Signals)

In the present disclosure, the reference signals are signals known to both a base station and a mobile station and each reference signal may be referred to as a Reference Signal (RS) or sometimes a pilot signal. The reference signal may be any of a DMRS, a Channel State Information-Reference Signal (CSI-RS), a Tracking Reference Signal (TRS), a Phase Tracking Reference Signal (PTRS), a Cell-specific Reference Signal (CRS), and a Sounding Reference Signal (SRS).

### (Time Intervals)

In the present disclosure, time resource units are not limited to one or a combination of slots and symbols, and may be time resource units, such as frames, superframes, subframes, slots, time slot subslots, minislots, or time resource units, such as symbols, Orthogonal Frequency Division Multiplexing (OFDM) symbols, Single Carrier-Frequency Division Multiplexing Access (SC-FDMA) symbols, or other time resource units. The number of symbols included in one slot is not limited to any number of symbols exemplified in the embodiment(s) described above, and may be other numbers of symbols.

### (Frequency Bands)

The present disclosure may be applied to any of a licensed band and an unlicensed band.

### (Communication)

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

In addition, the present disclosure may be applied to any of a terrestrial network or a network other than a terrestrial network (NTN: Non-Terrestrial Network) using a satellite or a High Altitude Pseudo Satellite (HAPS). In addition, the present disclosure may be applied to a network having a large cell size, and a terrestrial network with a large delay compared with a symbol length or a slot length, such as an ultra-wideband transmission network.

### (Antenna Ports)

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

As described above, the embodiments of the present disclosure provide an advanced communication system, communication methods and communication apparatuses for multi-PRACH transmissions that advantageously achieve improved performance gain of coverage among multiple PRACH transmissions.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication apparatus.

Some non-limiting examples of such communication apparatus include a phone (e.g, cellular (cell) phone, smart phone), a tablet, a personal computer (PC) (e.g, laptop, desktop, netbook), a camera (e.g, digital still/video camera), a digital player (digital audio/video player), a wearable device (e.g, wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g, an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

Further described below are statements applying to various embodiments of the present invention:

Statement 1. A communication apparatus comprising: a receiver, which in operation, receives control information relating to a multi-PRACH transmission, and a transmitter, which is operation, transmits a multi-PRACH transmission based on the control information, the multi-PRACH transmission comprising a plurality of PRACH transmissions.

Statement 2. The communication apparatus of Statement 1, wherein the control information indicates a multi-PRACH transmission pattern for one or more transmission slots, and wherein the transmitter is further configured to transmit the multi-PRACH transmission over the one or more transmission slots based on the multi-PRACH transmission pattern.

Statement 3. The communication apparatus of Statement 2, wherein the control information further indicates a different multi-PRACH transmission pattern for each of one or more coverage enhancement (CE) levels, wherein the communication apparatus further comprises: circuitry, which in operation, determines a CE level for the multi-PRACH transmission, and wherein the transmitter is further configured to transmit the multi-PRACH transmission based on a multi-PRACH transmission pattern that corresponds to the determined CE level.

Statement 4. The communication apparatus of Statement 2, wherein the control information further indicates a different number of transmission slots for each of the one or more CE levels, and wherein the transmitter is further configured to transmit the multi-PRACH transmission within the number of transmission slots corresponding to the determined CE level.

Statement 5. The communication apparatus of Statement 2, further comprising: circuitry, which in operation, determines a duration and a starting position for each PRACH transmission of the multi-PRACH transmission within the one or more transmission slots, and wherein the transmitter is further configured to transmit the multi-PRACH transmission based on the determined durations and starting positions.

Statement 6. The communication apparatus of Statement 2, further comprising: circuitry, which in operation, determines a plurality of RACH occasions (ROs) comprising durations and starting positions for a subset of the multi-PRACH transmission within a first slot of the one or more transmission slots, and repeats the determined ROs for each remaining slot of the one or more transmission slots; wherein the transmitter is further configured to transmit the multi-PRACH transmission over the one or more transmission slots based on the determined ROs.

Statement 7. The communication apparatus of Statement 2, further comprising: circuitry, which in operation, identifies one or more PRACH transmissions of the multi-PRACH transmission over one or more slot boundaries of the one or more transmission slots; wherein the transmitter is further configured to transmit the multi-PRACH transmission over the one or more transmission slots without the identified one or more PRACH transmissions.

Statement 8. The communication apparatus of Statement 2, further comprising: circuitry, which in operation, identifies one or more PRACH transmissions of the multi-PRACH transmission over one or more slot boundaries of the one or more transmission slots, and generates a PRACH preamble of each of the multi-PRACH transmission including the one or more identified PRACH transmissions; wherein the transmitter is further configured to transmit the multi-PRACH transmission including transmitting the identified one or more PRACH transmissions over the one or more slot boundaries.

Statement 9. The communication apparatus of Statement 2, further comprising: circuitry, which in operation: determines a plurality of PRACH resources for the multi-PRACH transmission based on the multi-PRACH transmission pattern, wherein each of the plurality of PRACH resources comprising dedicated radio resources and/or PRACH preambles for a different CE level, and determines a CE level for the multi-PRACH transmission; wherein the transmitter is further configured to transmit the multi-PRACH transmission based on the each of the plurality of PRACH resources that corresponds to the determined CE level.

Statement 10. The communication apparatus of Statement 5, wherein the circuitry is further configured to determine one or more smaller sub-patterns within the multi-PRACH transmission pattern if a condition is met, wherein the condition is to handle a collision between any PRACH transmission of the multi-PRACH transmission and a slot boundary, and/or a collision between any PRACH transmission of the multi-PRACH transmission and either other uplink transmission or downlink reception with higher priority.

Statement 11. The communication apparatus of Statement 10, wherein the condition is the multi-PRACH transmission pattern is longer than a maximum duration of the communication apparatus that is able to maintain phase continuity and power consistency.

Statement 12. The communication apparatus of Statement 1, wherein the control information indicates a plurality of RACH occasions (ROs) for the multi-PRACH transmission, and wherein the transmitter is further configured to transmit the multi-PRACH transmission based on the indicated plurality of ROs.

Statement 13. The communication apparatus of Statement 1, wherein the control information is indicated by one or a combination of a downlink control information, a table-based information, an uplink control information, medium access control control element (MAC CE), or radio resource control (RRC).

Statement 14. The communication apparatus of Statement 1, wherein the control information indicates one or more beams for uplink transmission, and the transmitter is further configured to transmit a multi-PRACH transmission by using only one of the indicated one or more beams.

Statement 15. The communication apparatus of Statement 1, wherein the control information indicates one or more beams for uplink transmission, and wherein the transmitter is further configured to transmit a multi-PRACH transmission by using a subset of the indicated one or more beams.

Statement 16. The communication apparatus of Statement 14 or Statement 15, wherein the transmitter is further configured to transmit a multi-PRACH transmission only after the communication apparatus reaches a maximum transmit power.

Statement 17. The communication apparatus of Statement 14 or Statement 15, wherein the transmitter is further configured to transmit a multi-PRACH transmission before the communication apparatus reaches a maximum transmit power.

Statement 18. The communication apparatus of Statement 14, wherein the transmitter is further configured to transmit a coherent multi-PRACH transmission.

Statement 19. The communication apparatus of Statement 1, wherein the control information indicates a plurality of preamble formats, and the transmitter is further configured to determine a combination of preamble formats from the indicated plurality of preamble formats to transmit the multi-PRACH transmission.

Statement 20. A base station comprising: circuitry, which in operation, generates control information relating to a multi-PRACH transmission; a transmitter, which in operation, transmits the control information to a communication apparatus; and a receiver, which in operation, receives the multi-PRACH transmission from the communication apparatus.

Statement 21. A communication method comprising: receiving control information relating to a multi-PRACH transmission, and transmitting a multi-PRACH transmission based on the control information, the multi-PRACH transmission comprising a plurality of PRACH transmissions.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1.-15. (canceled)

16. A communication apparatus, comprising:
a receiver, which, in operation, receives control information relating to repetitions of a physical random access channel (PRACH), and
a transmitter, which is operation, transmits the repetitions of the PRACH based on the control information.

17. The communication apparatus of claim 16, wherein a number of the repetitions of the PRACH is determined based on a Reference Signal Receive Power (RSRP) threshold.

18. The communication apparatus of claim 16, wherein a first number of the repetitions of the PRACH used for a first Reference Signal Receive Power (RSRP) is smaller than a second number of the repetitions of the PRACH used for a second RSRP, which is smaller than the first RSRP.

19. The communication apparatus of claim 16, wherein the transmitter transmits the repetitions of the PRACH over multiple slots, wherein a number of the repetitions of the PRACH in each of the multiple slots is the same.

20. The communication apparatus of claim 16, wherein the transmitter transmits the repetitions of the PRACH over multiple slots, wherein a starting position of the repetitions of the PRACH in each of the multiple slots corresponds to the same symbol index.

21. The communication apparatus of claim 16, wherein the transmitter transmits the repetitions of the PRACH on a set of PRACH occasions (ROs) using same frequency resources.

22. The communication apparatus of claim 21, wherein the set of PRACH occasions (ROs) and another set of ROs are assigned in different frequency resources.

23. A communication method, comprising:
receiving control information relating to repetitions of a physical random access channel (PRACH), and
transmitting the repetitions of the PRACH based on the control information.

24. An integrated circuit, comprising:
reception circuitry, which, in operation, controls a reception of control information relating to repetitions of a physical random access channel (PRACH), and
transmission circuitry, which, in operation, controls a transmission of the repetitions of the PRACH based on the control information.

25. The integrated circuit of claim 24, wherein a number of the repetitions of the PRACH is determined based on a Reference Signal Receive Power (RSRP) threshold.

26. The integrated circuit of claim 24, wherein a first number of the repetitions of the PRACH used for a first Reference Signal Receive Power (RSRP) is smaller than a second number of the repetitions of the PRACH used for a second RSRP, which is smaller than the first RSRP.

27. The integrated circuit of claim 24, wherein the transmission circuitry controls the transmission of the repetitions of the PRACH over multiple slots, wherein a number of the repetitions of the PRACH in each of the multiple slots is the same.

28. The integrated circuit of claim 24, wherein the transmission circuitry controls the transmission of the repetitions of the PRACH over multiple slots, wherein a starting position of the repetitions of the PRACH in each of the multiple slots corresponds to the same symbol index.

29. The integrated circuit of claim 24, wherein the transmission circuitry controls the transmission of the repetitions of the PRACH on a set of PRACH occasions (ROs) using same frequency resources.

30. The integrated circuit of claim 29, wherein the set of PRACH occasions (ROs) and another set of ROs are assigned in different frequency resources.
